(19) United States
(12) Patent Application Publication
(10) Pub. No.: US 2015/0356601 A1
(43) Pub. Date: Dec. 10, 2015

(54) RECOMMENDATIONS BASED ON PURCHASE PATTERNS

(71) Applicant: Haiyun LU, Singapore (SG)

(72) Inventor: Haiyun LU, Singapore (SG)

(21) Appl. No.: 14/300,248

(22) Filed: Jun. 10, 2014

(51) Int. Cl. G06Q 30/02

(52) U.S. Cl. CPC G06Q 30/0255; G06Q 30/0261; G06Q 30/0269

(57) ABSTRACT

Disclosed herein are technologies for a method of deriving recommendations based on purchase patterns to improve e-commerce mobile transactions. In some implementations, a wireless device is programmed to automatically receive messages. The wireless device may display the recommended category of purchases based on a purchase pattern history made in the wireless device. This Abstract is submitted with the understanding that it will not be used to interpret or limit the scope or meaning of the claims.

### TECHNICAL FIELD

The present disclosure relates generally to a framework for deriving recommendations based on purchase patterns to improve e-commerce mobile transactions.

### BACKGROUND

With the rapid development of computer technologies such as the Internet, e-commerce industry continues to boost its business. Personalized recommendation systems, for example, are of great interest for the e-commerce industry. Such systems are used to recommend products that may interest a particular buyer.

Recommendation systems allow buyers to find what they need without browsing through catalogs. They also enable sellers to increase the conversion rate by attracting buyers with those products that they might prefer. Thus, benefits for both parties are furnished by recommendation systems. As a result of this importance, many studies have been devoted to improving the knowledge and techniques for recommendation systems.

As mobile devices gain massive popularity, mobile e-commerce becomes much more important to the industry. Consumers may use the mobile device to complete a transaction anywhere and anytime. In the context of mobile environment, a lot more information about buyers can be obtained, such as location. Here, location based recommendation is preferred for business such as restaurants and tourist attractions and is often related to social network.

When investigating recommendation mechanisms of the mobile version of an online shopping website for coupon deals, it was found that, in real business transactions, the information about customers is limited. In most cases, information about customer profile, product preference or product ratings, is not available. The most relevant information about a particular customer is her purchase history and current location. In this case, a straightforward approach is to recommend deals that are in the vicinity. However, such recommendation may suffer from a higher probability of inaccuracy.

### SUMMARY

Disclosed herein is a framework for providing e-commerce recommendations. The framework may include determining a location of a device, retrieving a category of products and/or services based on the determined location, and retrieving a purchase history of products and/or services related to the device, calculating a probability of purchasing products and/or services based on purchase patters, and recommending products and/or services.

This summary is provided to introduce a selection of concepts in a simplified form that are further described below in the following detailed description. It is not intended to identify features or essential features of the claimed subject matter, nor is it intended to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary scenario for a method of deriving recommendations based on purchase patterns to improve e-commerce mobile transactions;

FIG. 2A illustrates an exemplary device system as described in present implementations herein;

FIG. 2B illustrates an exemplary simulation graph of the algorithm as described in present implementations herein;

FIG. 3 illustrates an exemplary process for implementing, at least in part, the technology described herein; and

FIG. 4 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for a method of deriving recommendations based on purchase patterns to improve e-commerce mobile transactions. Examples of users include individuals, business or corporate entities, etc. Technologies herein may be applied to computing and mobile applications.

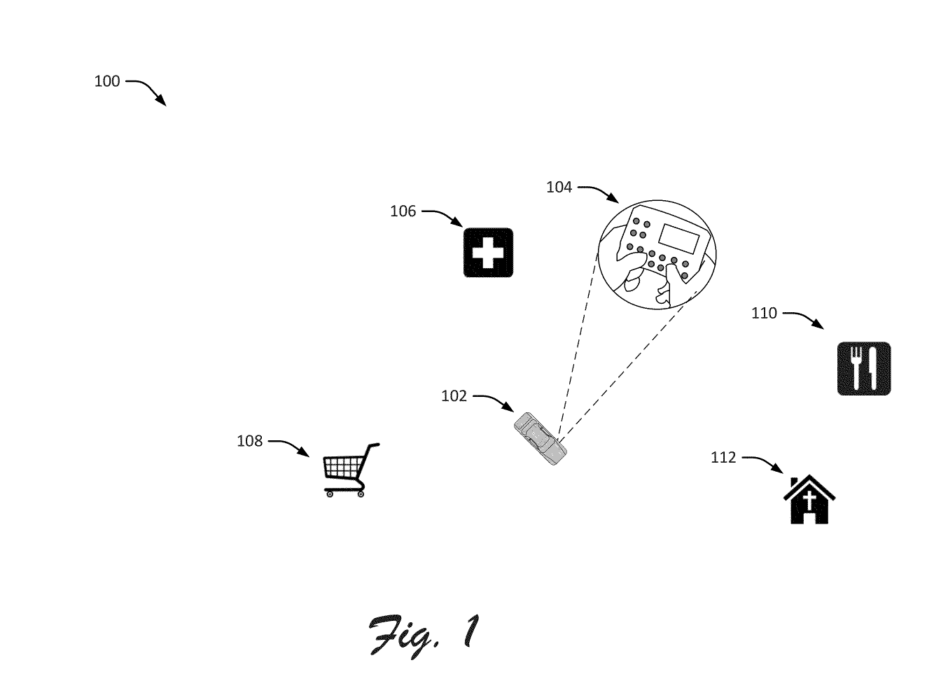

FIG. 1 includes an exemplary neighborhood map 100 that will be used to illustrate an exemplary scenario in which one or more implementations of the technology described herein may be employed. For illustration purpose, the map 100 shows an automobile 102 on a road that has a user-driver or passenger (not shown) with an active wireless device 104. With implementations described herein, the wireless device 104 may be programmed to automatically receive messages at designated points along a route. For example, a text message recommending products or services to be purchased may be automatically received when the user-driver is five minutes away from a drug store 106, a grocery 108, a restaurant 110, or a church service 112. In this example, the user-driver or passenger activated an e-commerce mobile app (not shown) in the wireless device 104 and the wireless device 104 displays the recommended category of purchases based on a purchase pattern history made in the wireless device 104.

For example, when the wireless device 104 is within the vicinity of the grocery 108, the e-commerce mobile app facilitates displaying of top items that the user may possibly purchase based from the previous grocery items that were purchased through the wireless device 104. In this example, the e-commerce mobile app performs an algorithm that calculates a probability that a particular category of items, product, or services may be purchased by the user. The algorithm, for example, is based from the present location and the previous purchase patterns made in the same wireless device 104.

Examples of the wireless device 104 may include (but are not limited to) a mobile phone, a cellular phone, a smartphone, a personal digital assistant, a tablet computer, a netbook, a notebook computer, a laptop computer, a multimedia playback device, a digital music player, a digital video player, a navigational device, a digital camera, and the like. In these examples, the wireless device 104 may run different mobile web applications in its browser or operating system. One of the mobile web applications, for example, may recommend the product or services to the user as described above.

Although FIG. 1 illustrates a limited number of products or services, the implementations described herein may apply to multiple numbers of other categories of products and/or services. For example, a coupon deal may include wellness, dining, physical activity, and the like.

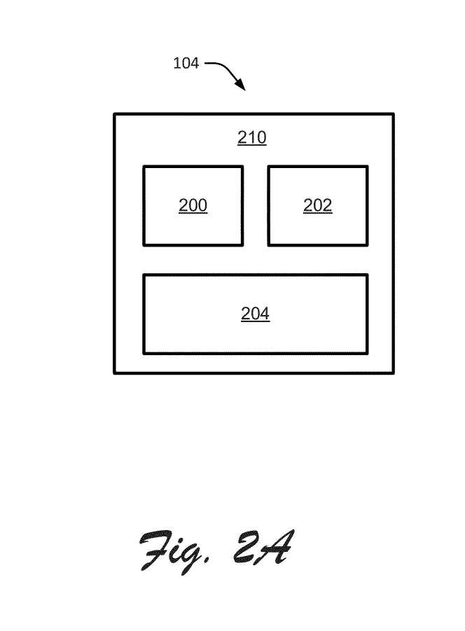

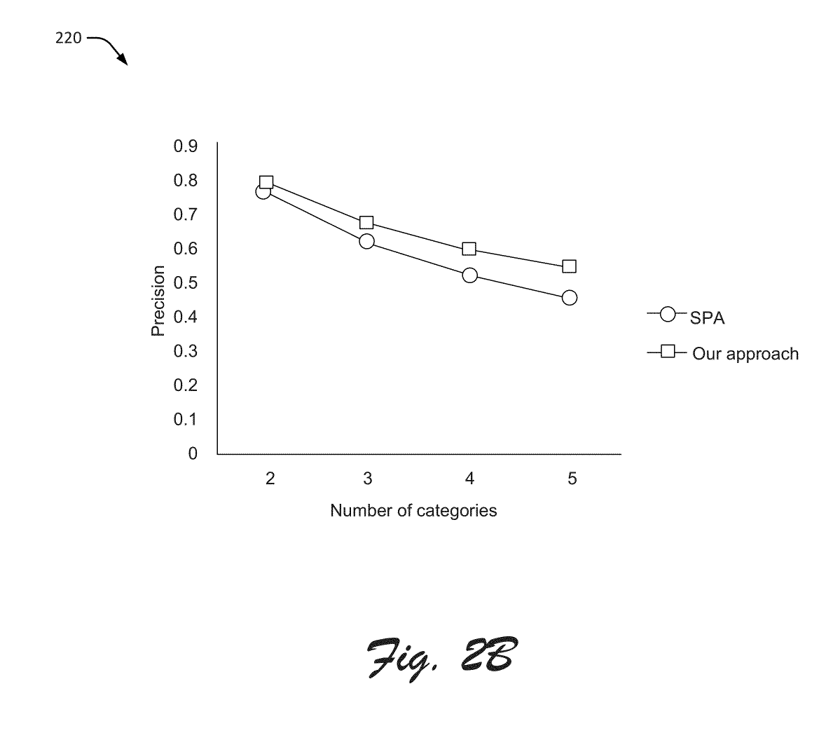

FIG. 2A is an exemplary system 210 of the device 104. The system 210 implements the method of deriving recommendations based on purchase patterns to improve e-commerce mobile transactions as described in the present implementations herein.

As shown, the system 210 includes a global positioning system (GPS) 200, one or more processors 202 and a user interface 204.

In an implementation, the GPS 200 facilitates determination of current location of the device 104 with respect to the products and/or services such as the drug store 106, grocery 108, restaurant 110 and the like. In this implementation, the determination of the current location of the device 104 is utilized as a factor or variable in calculating the recommendations to be displayed at the user interface 204.

The one or more processors 202, for example, are configured to: retrieve a category of products and/or services based on the determined current location of the device 104; retrieve a purchase pattern history of the products and/or services that were purchased through the device 104; and to perform an algorithm that calculates a probability of purchasing the products and/or services based on the retrieved purchase patterns.

FIG. 2B is an exemplary simulation graph 220 that compares the algorithm as described in the implementations herein with the graph of a sequential pattern analysis (SPA).

When applying recommendation techniques to a mobile environment, we are facing some new challenges as well as new opportunities. The mobile screens are smaller and thus fewer products are browsed. As a result, it is difficult to use users' browsing behavior in methods like collaborative filtering. However, more information can be obtained from users' mobile devices, such as location, dwell time and direction.

Location has been widely used in mobile environment to provide value-add services. For recommendation systems related to location based business such as restaurants or tourist attractions, the information of location can be helpful. However, there is a problem with limited amount of user information. In most cases, user profiles, preferences, location histories, item ratings are not available. Furthermore, in the mobile shopping website for coupon deals, the life span of deals is only several days. All these limitations and constraints make it difficult to apply existing techniques to build recommendation systems. Therefore, the implementations described herein analyze the purchase history of the user, find their purchase patterns related to the user behavior and then predict information of the next possible purchase in a particular location.

Purchase history of a user is a series of transactions ordered by the transaction time. Due to the nature of coupon deals, information such as deal titles and descriptions are not following any standard, and thus make it hard to use. To this end, an implementation described herein looks at the category information of the transaction. Thus, the purchase history in this context is just the category sequence. For example, a user has 4 transactions with category sequence “BAAC.” It means that the first purchase is a deal in category B, the second and the third purchases are both in category A and the last purchase is in category C.

Given a set of category sequences, the problem is to find purchase patterns related to the user behavior that can be used to make recommendations. Note that in this case, the recommendation will be the category as well. A classical approach to solve this type of problem is to use sequential pattern analysis (SPA). In this approach, frequently occurring patterns are extracted from all subsequences of the given set of sequences. Each pattern is associated with a support value. Then all subsequences of a target user's sequence data is enumerated to match with the first part of identified patterns. The other part of a matching pattern becomes a candidate of the recommendation. The support values are summed up for each associated candidate, and the top-scored candidate will be recommended.

However, this approach is not suitable in certain cases. In real business, purchase histories of users vary from 1 transaction to up to 100 transactions, and the number of users is generally very large. Using sequential pattern analysis, the patterns derived are often associated with a very small support value, such as 0.01. Also, this approach uses all subsequences, which may derive patterns relating distant transactions. Such patterns may not be relevant because coupon deals have short life spans and recency is important

In an implementation, the algorithm described herein analyzes purchase patterns by using consecutive subsequences. Consecutive subsequences are a subset of all subsequences. The consecutiveness ensures the recency of extracted patterns. For example, a user's purchase history is “BBAACCB”, and then the consecutive subsequences are:

Length 1: B, A, C

Length 2: BB, BA, AA, AC, CC, CB

Length 3: BBA, BAA, AAC, ACC, CCB

Length 4: BBAA, BAAC, AACC, ACCB

Length 5: BBAAC, BAACC, AACCB

Length 6: BBAACC, BAACCB

Length 7: BBAACCB

Among these subsequences, the focus is on those with length smaller or equal to 6. This is to avoid long patterns, as the aim is to maintain recency. An additional step is applied to further generalize the consecutive subsequences. Category information is replaced by the order of appearance, such that the purchase patterns extracted can better represent user behaviors. For example, the above mentioned consecutive subsequences are further generalized as:

Length 1: 1

Length 2: 11, 12

Length 3: 112, 122

Length 4: 1122, 1223

Length 5: 11223, 12233

Length 6: 112233, 122331

In an implementation, subsequences “BB”, “AA” and “CC” are now generalized as the same “11”. Subsequences “BA”, “AC” and “CB” are now generalized as “12”. Next, all eligible subsequences from users are analyzed to build a conditional probability model. This model computes the conditional probability of a category matching the next purchase based on a given sequence. The conditional probability is given by the following equation (1):

$$P ( N = c \vert H = s ) = \frac{P ( H = s ⋂ N = c )}{P ( H = s )} \qquad ( 1 )$$

where N=c denotes the event of a category c matching the next purchase and H=s denotes the event of category sequence s being the purchase history. For example, if there are x occurrences of pattern “1” and y occurrences of pattern “12”, then the probability of “2” matching next purchase given a purchase history of “1” is given by, P(N=“2”|H=“1”)=y/x.

With the conditional probability model, we are able to make recommendations. For each possible category, the probability of such category being the next purchase is computed based on the given purchase history. Here, eligible suffix subsequences of the target user's purchase history are used. For example, if a user with purchase history “BBAACCB” is the target user, the following suffix subsequences need to be examined: “B,” “CB,” “CCB,” “ACCB,” and “AACCB.” These suffix subsequences are served as conditions to compute the conditional probability. For example, to compute the probability of category “B” matching the next purchase, then N=“B” and there are five different cases of H in (1). Note that the generalized form of subsequences is used in the computation. Five probabilities are computed as follows and they are summed up to be the score of category “B” for recommendation:

P(N=“B”|H=“B”)=P(N=“1”|H=“1”)

P(N=“B”|H=“CB”)=P(N=“2”|H=“12”)

P(N=“B”|H=“CCB”)=P(N=“2”|H=“112”)

P(N=“B”|H=“ACCB”)=P(N=“3”|H=“1223”)

P(N=“B”|H=“AACCB”)=P(N=“3”|H=“11223”)

After that, all possible candidates of N are examined. The one with the highest score is selected as the final recommendation. This recommendation is, for example, employed on mobile devices for location based recommendation.

In the implementations described above, the approach of recommendation is based on purchase patterns. In other words, the purchase history of users is analyzed to find their purchase patterns related to user behavior. These patterns are then used to predict the category of next possible purchase in a particular location.

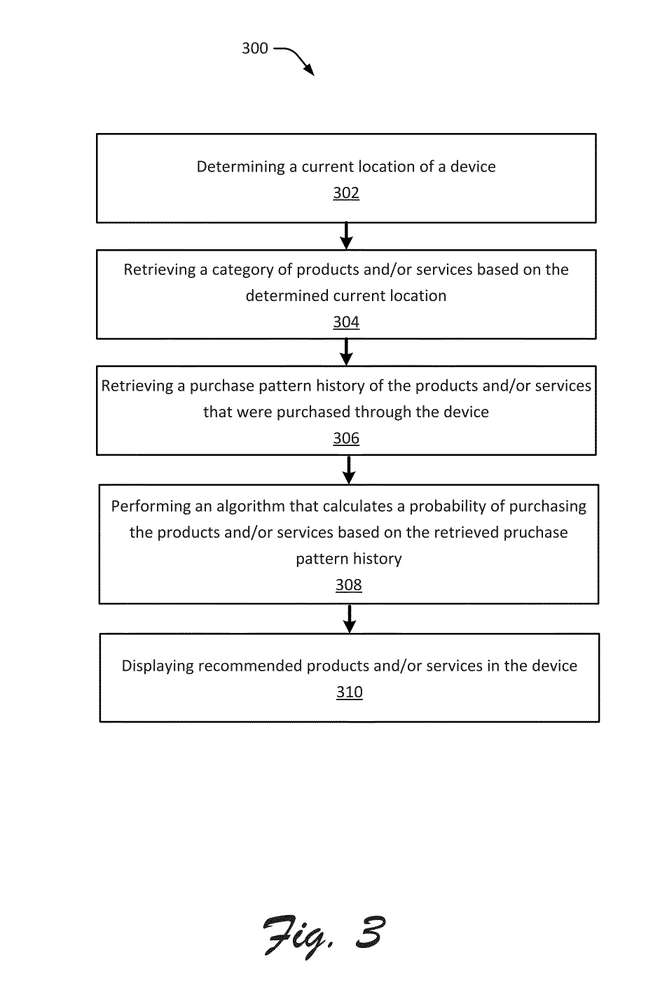

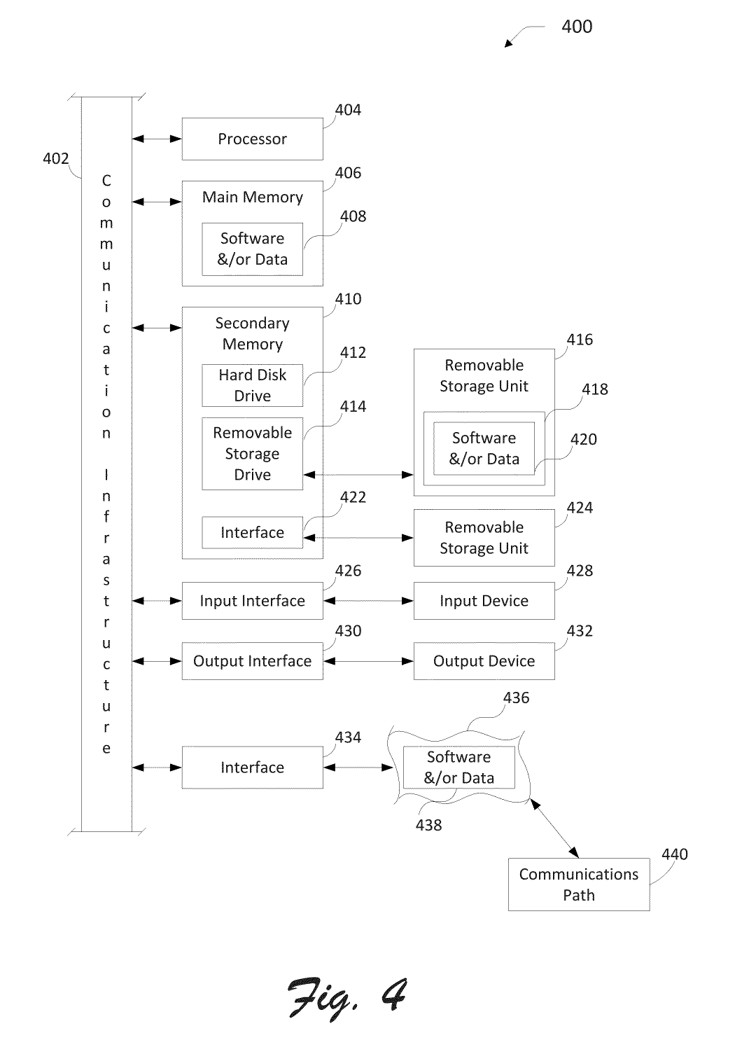

FIG. 3 illustrates an exemplary process 300 for implementing, at least in part, the technology described herein. In particular, process 300 depicts a method of deriving recommendations based on purchase patterns to improve e-commerce mobile transactions. The process 300 may be performed by a computing device or devices. An example architecture of such a computer device is described below with reference to FIG. 4. In this particular example, the process 300 describes that certain acts are to be performed at or by a user or a system.

At 302, determining a current location of a device is performed.

At 304, retrieving a category of products and/or services based on the determined current location is performed. For example, the products or services that are within a vicinity of the current location of the device may include the drug store 106, grocery 108, and the like.

At 306, retrieving a purchase pattern history of the products and/or services that were purchased through the device is performed.

At 308, performing an algorithm that calculates a probability of purchasing the products and/or services based on the retrieved purchase pattern history is performed.

At 310, displaying recommended products and/or services in the device is performed.

FIG. 4 illustrates an exemplary system 400 that may implement, at least in part, the technologies described herein. The computer system 400 includes one or more processors, such as processor 404. Processor 404 can be a special-purpose processor or a general-purpose processor. Processor 404 is connected to a communication infrastructure 402 (for example, a bus or a network). Depending upon the context, the computer system 400 may also be called a client device.

Computer system 400 also includes a main memory 406, preferably Random Access Memory (RAM), containing possibly inter alia computer software and/or data 408.

Computer system 400 may also include a secondary memory 410. Secondary memory 410 may include, for example, a hard disk drive 412, a removable storage drive 414, a memory stick, etc. A removable storage drive 414 may comprise a floppy disk drive, a magnetic tape drive, an optical disk drive, a flash memory, or the like. A removable storage drive 414 reads from and/or writes to a removable storage unit 416 in a well-known manner. A removable storage unit 416 may comprise a floppy disk, a magnetic tape, an optical disk, etc. which is read by and written to by removable storage drive 414. As will be appreciated by persons skilled in the relevant art(s) removable storage unit 416 includes a computer usable storage medium 418 having stored therein possibly inter alia computer software and/or data 420.

In alternative implementations, secondary memory 410 may include other similar means for allowing computer programs or other instructions to be loaded into computer system 400. Such means may include, for example, a removable storage unit 424 and an interface 422. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 424 and interfaces 422 which allow software and data to be transferred from the removable storage unit 424 to computer system 400.

Computer system 400 may also include an input interface 426 and a range of input devices 428 such as, possibly inter alia, a keyboard, a mouse, etc.

Computer system 400 may also include an output interface 430 and a range of output devices 432 such as, possibly inter alia, a display, one or more speakers, etc.

Computer system 400 may also include a communications interface 434. Communications interface 434 allows software and/or data 438 to be transferred between computer system 400 and external devices. Communications interface 434 may include a modem, a network interface (such as an Ethernet card), a communications port, a Personal Computer Memory Card International Association (PCMCIA) slot and card, or the like. Software and/or data 438 transferred via communications interface 434 are in the form of signals 436 which may be electronic, electromagnetic, optical, or other signals capable of being received by communications interface 434. These signals 436 are provided to communications interface 434 via a communications path 440. Communications path 440 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 416, removable storage unit 424, and a hard disk installed in hard disk drive 412. Computer program medium and computer usable medium can also refer to memories, such as main memory 406 and secondary memory 410, which can be memory semiconductors (e.g. Dynamic Random Access Memory (DRAM) elements, etc.). These computer program products are means for providing software to computer system 400.

Computer programs (also called computer control logic) are stored in main memory 406 and/or secondary memory 410. Such computer programs, when executed, enable computer system 400 to implement the present technology described herein. In particular, the computer programs, when executed, enable processor 404 to implement the processes of aspects of the above. Accordingly, such computer programs represent controllers of the computer system 400. Where the technology described herein is implemented, at least in part, using software, the software may be stored in a computer program product and loaded into computer system 400 using removable storage drive 414, interface 422, hard disk drive 412 or communications interface 434.

The technology described herein may be implemented as computer program products comprising software stored on any computer useable medium. Such software, when executed in one or more data processing devices, causes data processing device(s) to operate as described herein. Exemplary illustrations of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more exemplary illustrations described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

What is claimed is:

1. A method of providing recommendations to improve e-commerce mobile transactions comprising:
determining a current location of a device;
retrieving a category of products or services based on the determined current location of the device;
retrieving a purchase pattern history of the products or services that were purchased through the device;
performing an algorithm that calculates a probability of purchasing the products or services based on the retrieved purchase patterns; and
displaying recommended products or services in the device.

2. The method according to claim 1, wherein the determining of current location is facilitated by a global positioning system (GPS) device.

3. The method according to claim 1, wherein the purchase pattern history is based on the products or services that were purchased within a period of time.

4. The method according to claim 1, wherein the calculated probability is combined with the determined current location of the device.

5. The method according to claim 1, wherein the calculating the probability utilizes consecutive subsequences that are a subset of all subsequences.

6. The method according to claim 1, wherein the calculating the probability utilizes a subsequence length of lesser than six to avoid long patterns.

7. The method according to claim 1, wherein the calculating the probability comprises generalizing consecutive subsequences.

8. The method according to claim 1, wherein the recommendation is based on a conditional probability model.

9. A device comprising:
a global positioning system (GPS) that tracks a current location of a device;
one or more processors configured to retrieve a category of products or services based on the determined current location of the device, wherein the one or more processors are further configured to
retrieve a purchase pattern history of the products or services that were purchased through the device, and
perform an algorithm that calculates a probability of purchasing the products or services based on the retrieved purchase patterns; and
a user interface configured to display recommended products or services in the device.

10. The device according to claim 9, wherein the purchase pattern history is based on the products or services that were purchased within a period of time.

11. The device according to claim 9, wherein the calculated probability is combined with the determined current location of the device.

12. The device according to claim 9, wherein the calculating the probability utilizes consecutive subsequences that are a subset of all subsequences.

13. The device according to claim 9, wherein the calculating the probability utilizes a subsequence length of less than six to avoid long patterns.

14. The device according to claim 9, wherein the calculating the probability comprises generalizing consecutive subsequences.

15. One or more computer-readable media storing processor-executable instructions that when executed cause one or more processors to perform operations that present e-commerce mobile transaction recommendations comprising:
determining a current location of a device;
retrieving a category of products or services based on the determined current location of the device;
retrieving a purchase pattern history of the products or services that were purchased through the device;
performing an algorithm that calculates a probability of purchasing the products or services based on the retrieved purchase patterns; and
recommending products or services based on the performing the algorithm.

16. The one or more computer-readable media according to claim 15, wherein the purchase pattern history is based on products and/or services that were purchased within a period of time.

17. The one or more computer-readable media according to claim 15, wherein the performing the algorithm that calculates the probability provides that the probability is combined with the determined current location of the device.

18. The one or more computer-readable media according to claim 15, wherein the performing the algorithm utilizes consecutive subsequences that are a subset of all subsequences.

19. The one or more computer-readable media according to claim 15, wherein the performing the algorithm utilizes a subsequence length of lesser than six to avoid long patterns.

20. The one or more computer-readable media according to claim 15, wherein the recommending is based on a conditional probability model.
